(19) United States
(12) Patent Application Publication
(10) Pub. No.: US 2007/0169602 A1
(43) Pub. Date: Jul. 26, 2007

(54) DEVICE FOR SCORING OR CUTTING SHEET MATERIAL

(76) Inventors: Michael E. Peterson, Fairfield, CT (US); P. Y. Gu, Guangzhou (CN)

Correspondence Address: WHYTE HIRSCHBOECK DUDEK S.C., ONE EAST MAIN STREET, SUITE 300, MADISON, WI, 53703-3300, US

(21) Appl. No.: 11/557,537

(22) Filed: Nov. 8, 2006

Related U.S. Application Data
(60) Provisional application No. 60/734,498, filed on Nov. 8, 2005.

(51) Int. Cl. B26D 1/18; B26D 5/08

(52) U.S. Cl. 83/485; 83/614

(57) ABSTRACT

The present invention is a device for manipulating sheet material having a base, a rail assembly pivotally mounted to the base, and at least one carriage having a protrusion for scoring or cutting sheet material. The rail assembly allows for the storage of at least one carriage while a user operates the trimmer using another carriage.

### CROSS REFERENCE TO RELATED APPLICATIONS

This application is related to and claims the benefit of U.S. Provisional Application Ser. No. 60/734,498 filed on Nov. 8, 2005, the contents of which are incorporated herein by reference thereto.

### BACKGROUND OF THE INVENTION

The present invention relates generally to devices for cutting and manipulating paper or other sheet material, and more specifically to a device for trimming or scoring paper in straight lines.

Trimmers with blades that slide along rails mounted to a cutting board are known in the art. These trimmers make reasonably accurate cuts, but suffer from several shortcomings. Conventional trimmers generally have a single blade carriage that allows for only one style of manipulating paper, and may or may not be removable for replacement when a blade dulls or when the trimmer requires repair. Such trimmers usually are suited for a single purpose, such as cutting, requiring a separate device to be used for other purposes such as scoring. The blade carriages of such trimmers generally conceal the blade from the user's perspective, requiring guesswork as to the precise location of the blade. In conventional trimmers, the rails tend to flex or otherwise deviate slightly from their intended position during use, which results in imprecise cutting. Conventional trimmers may contain surface extensions to expand the working surface, but these extensions tend to sag or bend when moved into an open position, resulting in a non-uniform working surface. Consequently, there exists a need for a trimmer that offers a plurality of carriages where one carriage can be used selectively without removal of another, that provides an indication of the precise location of the blade, that secures the position of the rail against the base, and that has a surface extension that ensures a uniform, planar working surface.

### SUMMARY OF THE INVENTION

The present invention is a device for scoring or cutting paper with a sliding mechanism mounted to a rail, conventionally known as a personal paper trimmer. The trimmer of the present invention has a base with a working surface designed to support a sheet material to be cut or scored. The base has a channel that generally defines a cutting path. The trimmer has a rail assembly pivotally connected to the cutting board, the rail assembly being pivotal in a direction substantially perpendicular to the channel. To secure the position of the rail against the base in the operative position, the base may have a rib that registers with a corresponding recess in the rail. The rail assembly may have a cutting portion and two storage portions, the storage portions contiguous with the cutting length.

The trimmer of the present invention has at least one carriage that is slidably connected to the rail assembly. The carriage has a protrusion that is received within the channel when the rail is in a closed position. The protrusion of the present invention may be a blade or a scorer. The invention may have both a blade and a scorer, each protruding from separate carriages. The blade or scorer may have a coating. The carriage may have an indicator to represent to the user the precise location, shape, or function of the protrusion.

The present invention may have a swing-out arm pivotally connected to the base, which arm has a working surface that is flush with the working surface of the base. The trimmer may have measuring indicia to assist in precision cutting, on the working surface of the base, on the working surface of the swing-out arm, or on the rail. The rail may be transparent, to facilitate visibility of the material to be cut and assist in measuring.

### BRIEF DESCRIPTION OF THE DRAWINGS

Preferred embodiments of the invention are described below with reference to the following figures, which are provided for illustrative purposes only. The figures illustrate a best mode presently contemplated for carrying out the invention.

FIG. 1 is a perspective view of a trimmer with a rail assembly in an operative position and a swing-out arm in a closed position, according to one embodiment the present invention.

FIG. 2 is a top plan view of the trimmer of FIG. 1. with a rail assembly in an operative position and a swing-out arm in a closed position, according to one embodiment the present invention FIG. 3 is a top plan view of the trimmer of FIG. 1, with a rail assembly in an operative position and the swing-out arm in an open position.

FIG. 4 is a partial enlarged top perspective view of the trimmer of FIG. 1, with the rail assembly in an inoperative position.

FIG. 5 is a partially exploded view of the trimmer of FIG. 1.

FIG. 6 is a partial enlarged perspective of the trimmer of FIG. 1, with the rail an operative position.

FIG. 7 is a partial enlarged right elevational view of the carriages of the trimmer of FIG. 1.

FIG. 8. is a bottom plan view of the trimmer of FIG. 1, with the swing-out arm in a closed position.

FIG. 9. is a bottom plan view of the trimmer of FIG. 1, with the swing-out arm in an open position.

FIG. 10 is a partial enlarged top perspective view of the trimmer of FIG. 1, with the swing-out arm in a partially closed position.

FIG. 11 is a partial enlarged bottom perspective view of the trimmer of FIG. 1, with the swing-out arm in a partially closed position.

FIG. 12 is a front elevational view of the trimmer of FIG. 1.

### DETAILED DESCRIPTION OF THE PREFERRED EMBODIMENT

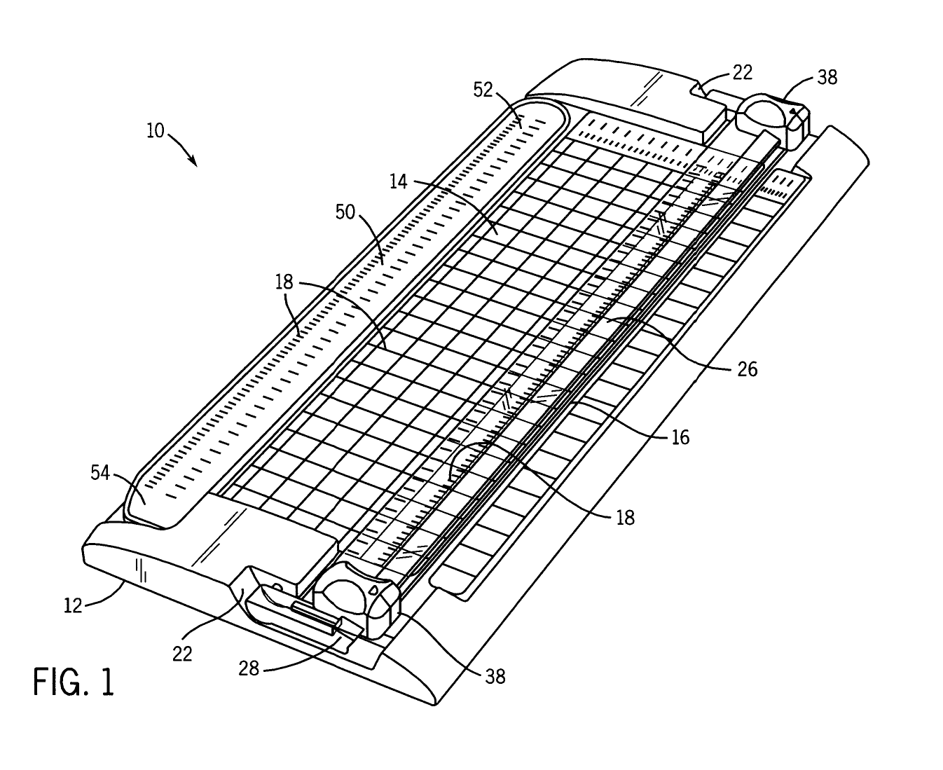

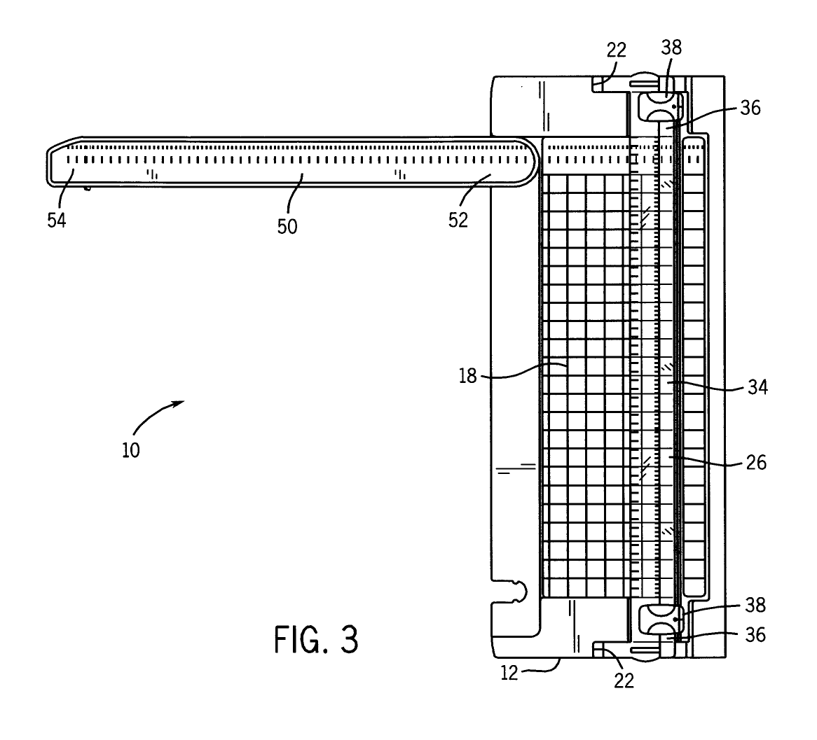

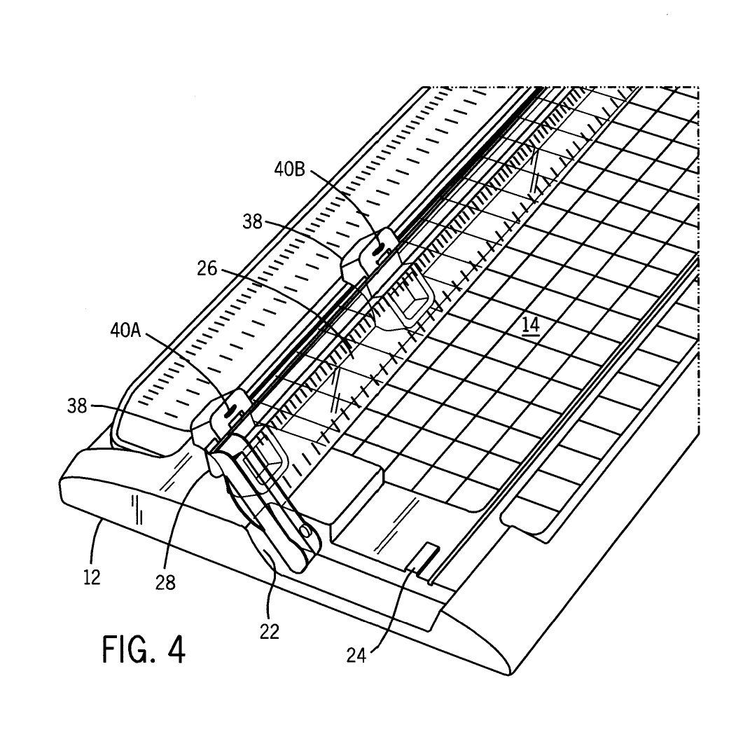

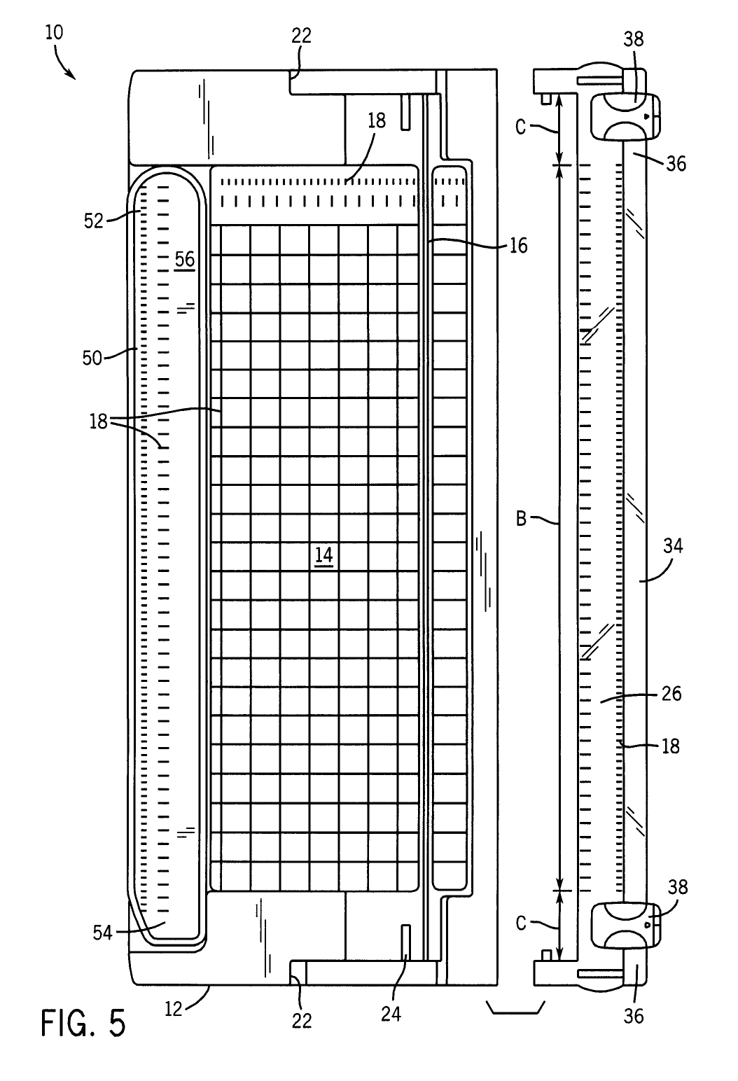

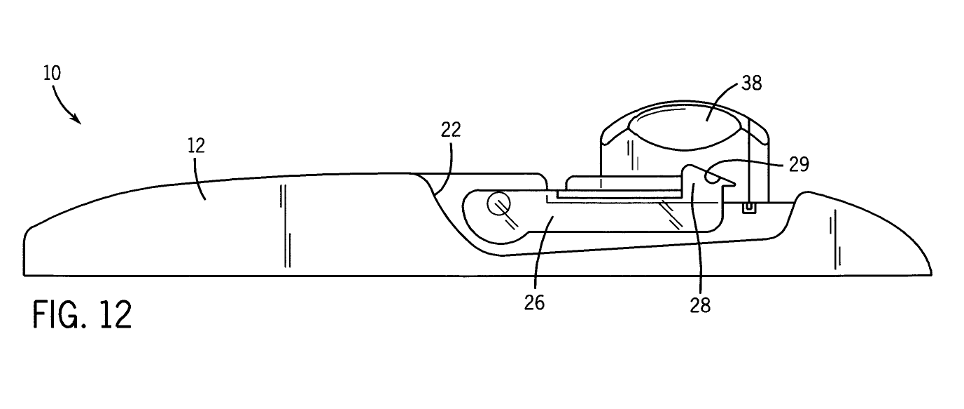

Referring to FIGS. 1-3, the present invention is a trimmer 10 having a base 12 with a working surface 14 for supporting a sheet material (not shown). The working surface 14 has a first length A, and the base 12 has a longitudinal channel 16 parallel to the first length A of the working surface 14. The working surface 14 may have measuring indicia 18, such as a grid or a ruler, or a combination of a grid and a ruler. The base 12 has a female pivot-receiving area (not shown), a stop point 22 and a rib 24, as shown in FIGS. 4 and 5. The stop point 22 also is shown in FIG. 12. The pivot-receiving area (not shown) may be any suitable shape, such as a recess or a hole to accommodate a pivot 32. The rib 24 generally is a plateau rising slightly above the plane of the working surface 14 and running parallel to the channel 16.

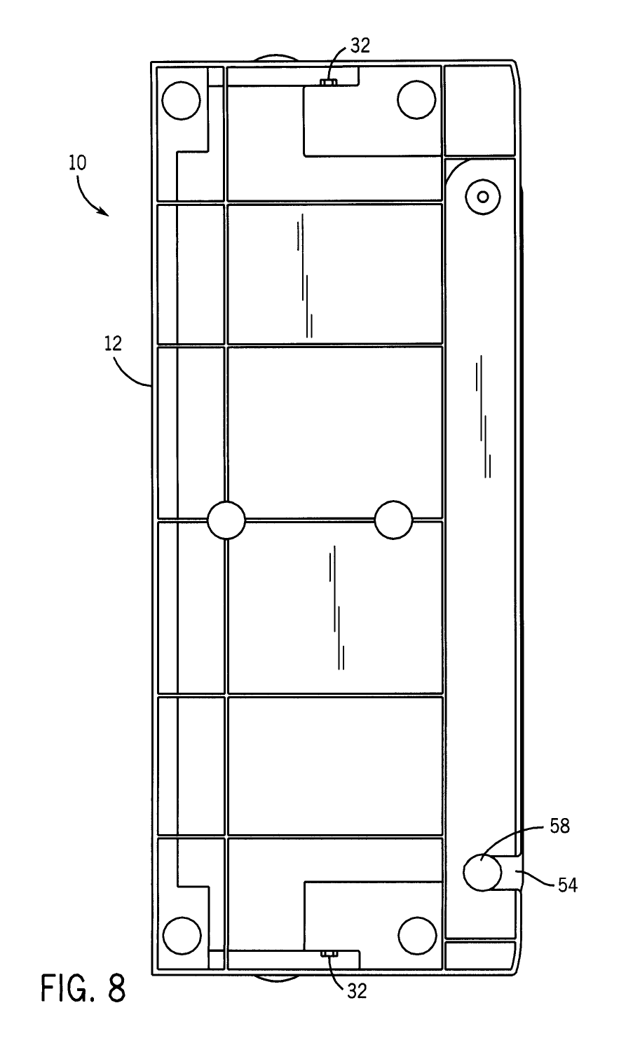

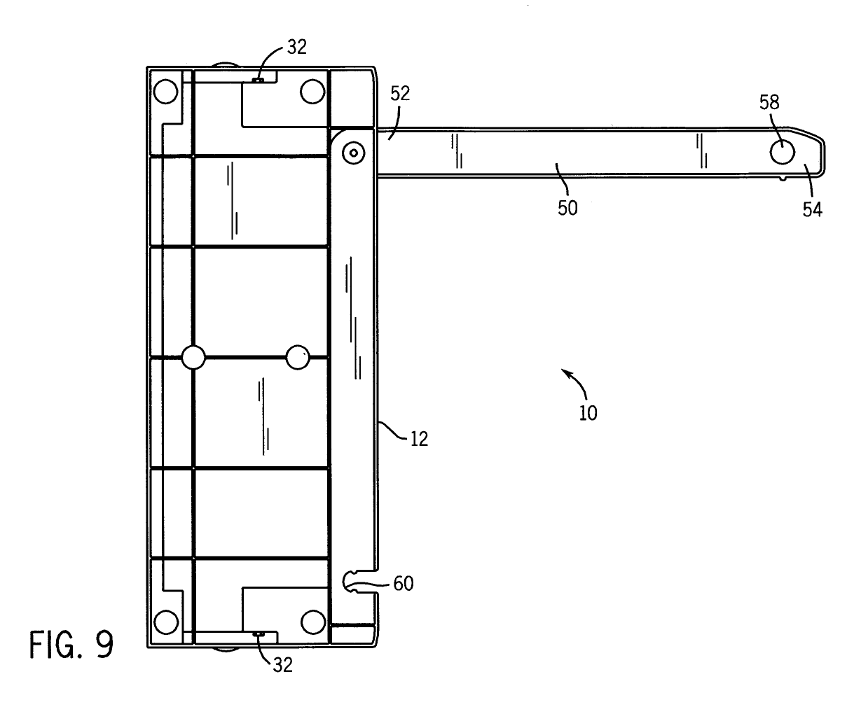

As further shown in FIGS. 1-3, the trimmer 10 also has a rail assembly 26 that is pivotally connected to the base 12. The rail assembly 26 has measuring indicia 18 and preferably is transparent to allow measuring and a view of the material to be cut (not shown). The rail assembly 26 has a male carriage-guiding portion 28, shown in FIGS. 1, 4 and 12, that runs at least the entire first length A of the working surface 14, and a rib-receiving recess 30 as shown in FIG. 4. The rail assembly 26 also has a male pivot 32, shown in FIGS. 8 and 9, which is received by the base 12 in the pivot-receiving area (not shown). In the preferred embodiment shown in FIGS. 1-3, the base has two symmetrical pivot receiving areas (not shown) two symmetrical stop points 22, and two symmetrical ribs 24, and the rail assembly 26 has two symmetrical pivots 32.

The rail assembly 26, pivotally connected to the base 12, pivots in a direction substantially perpendicular to the channel 16. The rail assembly 26 may be pivoted to an operative position as shown, for example, in FIGS. 1-3 where the rail assembly 26 rests substantially against the working surface 14 of the base 12. In the operative position, the rail assembly 26 receives the rib 24 snugly within the rib-receiving recess 30 to secure the rail assembly's 26 position against the base 12. The rail assembly 26 also may be pivoted to an inoperative position as shown in FIG. 4. Whereas the operative position requires the rail assembly to be substantially parallel to the working surface 14, an inoperative position generally requires the rail assembly 26 to be at an angle deviating from parallel with the base 12. In an inoperative position where the rail assembly 26 is at an angle at or greater than 90° from the working surface 14, the rail assembly 26 may rest against the stop point 22 of the base 12.

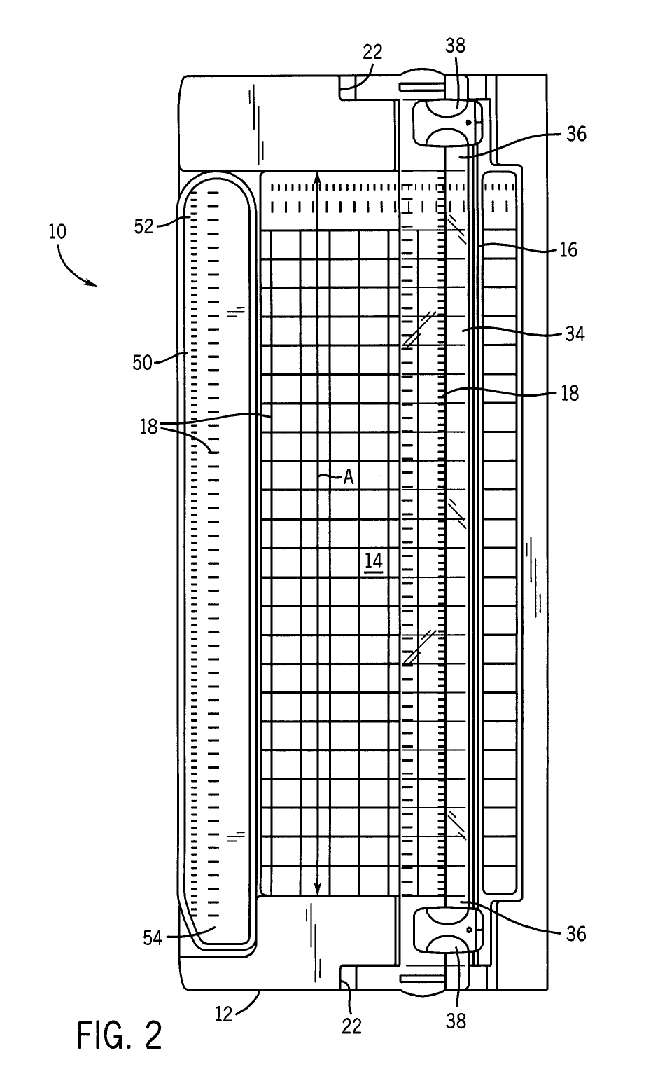

Referring now to FIGS. 2 and 5, the rail assembly 26 is generally parallel to and adjacent to the channel 16. The rail assembly 26 has a cutting portion 34 and two storage portions 36. In the preferred embodiment shown in FIGS. 1-3, the rail assembly 26 has two symmetrical storage portions 36. The cutting portion 34 has a second length B that is approximately equal to the first length A of the working surface 14. Each storage portion 36 is contiguous with the cutting portion 34, and each storage portion 36 has a third length C. Each storage portion 34 is sufficiently long to accommodate a first carriage 38 so that a second carriage 38 may be positioned far enough away from the cutting portion 34 so as not to interfere with the cutting motion of the first carriage 38 slid along the cutting portion 34.

Referring again to FIG. 4, an exemplary embodiment of the invention is shown having a base 12 with a male rib 24 that interacts with the female rib-receiving recess 30 of the rail assembly 26. The rib 24 and rib-receiving recess 30 are complementary in shape. The interaction of the rib 24 and rib-receiving recess 30 secures the position of the rail assembly 26 in an operative position against the working surface 14 of the base 12. The snug fit of the rib 24 within the rib-receiving recess 30 reduces flex in the rail assembly 26 and deviation from the intended position of the rail assembly 26 during use.

As shown in the embodiment in FIGS. 1-7, the trimmer has at least one carriage 38 slidably mounted to the rail assembly 26. As shown in FIGS. 1, 4 and 12, the carriage 38 is mounted on the carriage-guiding portion 28 of the rail assembly 26. The carriage 38 has a female rail-receiving portion 29 for receiving the carriage-guiding portion 28 of the rail assembly 26. In the embodiment shown, each carriage 38 slidably snap-fits to the carriage-guiding portion 28. Each carriage 38 has a protrusion 40A, 40B as shown in FIGS. 4 and 7. As shown in FIG. 7, the protrusions 40A, 40B are shown as a scorer 40A and a blade 40B. Each protrusion 40A, 40B may be made of any suitable material, such as steel, stainless steel, tool steel, 420 stainless steel or heat-treated stainless steel. A coating 42 may be disposed on each protrusion 40A, 40B to enhance hardness, durability, or resistance to corrosion or to provide an aesthetically acceptable appearance. Suitable coatings may include titanium nitride, chromium nitride, or a combination of titanium nitride and chromium nitride. Suitable coatings are known in the art, such as disclosed in U.S. patent application Ser. No. 10/720,578, U.S. patent application Ser. No. 11/231,259, and U.S. patent application Ser. No. 11/231,151, which are incorporated herein by reference. When the rail assembly 26 is in an operative position, each protrusion 40A, 40B is received within the channel 16. As further shown in FIG. 7, a carriage 38 may have an arcuate surface 44 adjacent to the protrusion 40B. An arcuate surface 44, as opposed to an angular or flat surface 46, helps to reduce the risk of damaging material to be cut (not shown) by inadvertent contact with a carriage 38.

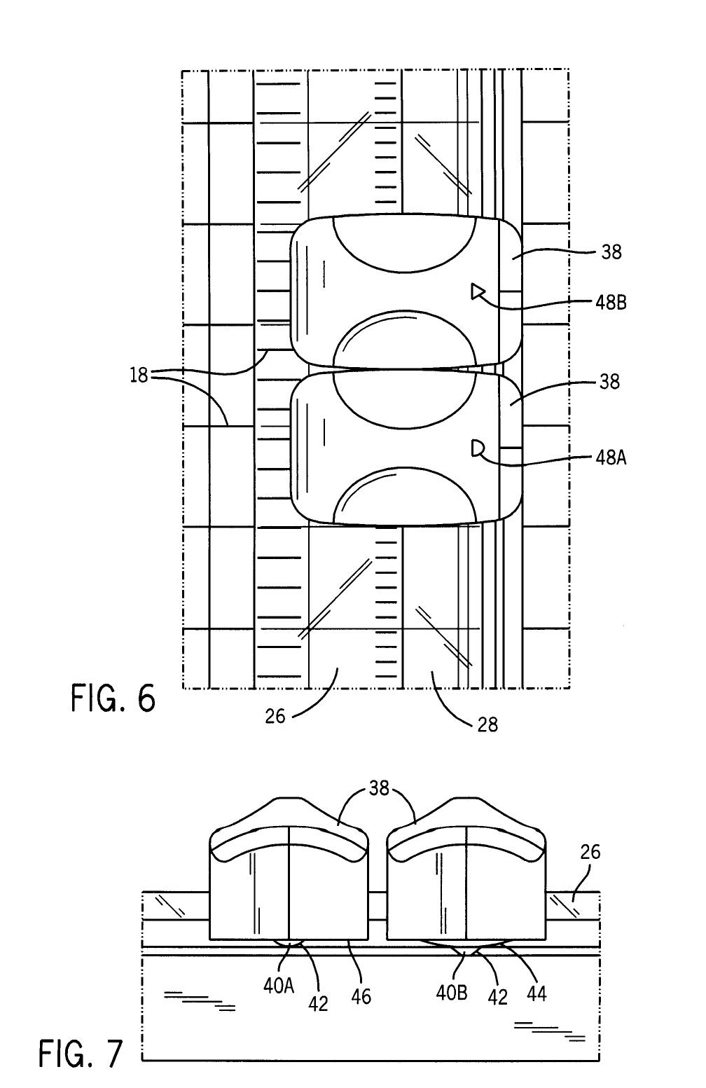

As shown in the embodiment of FIGS. 6 and 7, each carriage 38 has an indicator 48A, 48B, that represents the position of the protrusion 40A, 40B extending from the carriage 38. The indicator 48A, 48B also may signify the shape or function of the protrusion 40A, 40B. As FIGS. 6 and 7 demonstrate, a scorer 40A may be indicated by a half-circle shape 48A, and a blade 40B may be indicated by a triangle 48B.

Referring back to FIG. 2, each storage portion 36 of the rail assembly 26 is sized to receive a first carriage 38 for storage, such that a second carriage 38 may freely slide along the entire cutting portion 34 of the rail assembly 26. Having storage portions 36 permits a user to operate the trimmer 10 using a first carriage 38, such one containing a scorer 40A, while an unused second carriage 38, such as one containing a blade 38B may be slid onto a storage portion 36 of the rail assembly 26 and thus removed from the cutting portion 34 during use. Likewise, a user may operate the trimmer 10 using a second carriage, such as one containing a blade 40B, while an unused first carriage 38, such as one containing a scorer 40A may be slid onto a storage portion 36 of the rail assembly 26.

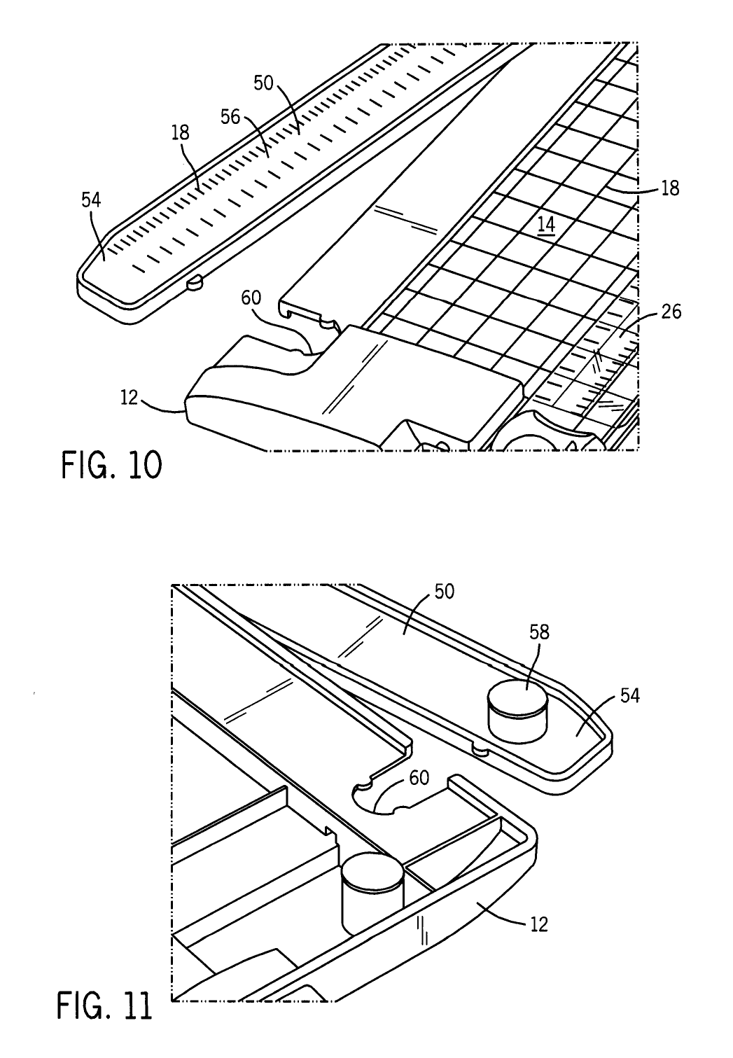

Referring again to FIGS. 1-3, the invention has a swing-out arm 50 to extend the working surface 14 of the base 12. The arm 50 has a first end 52 pivotally connected to the base 12 and a second end 54, which may swing freely towards or away from the base 12. The arm 50 has an arm working surface 56 that is flush with and substantially coplanar with the working surface 14 of the base 12. As shown in FIGS. 8-11, the arm 50 has a foot 58 shaped to removably snap-fit within a foot-receiving recess 60 in the base 12. As shown, the arm working surface 56 has measuring indicia 18.

Many variations of the above invention are contemplated. For example, the invention may include combinations of two carriages 38 each having a blade 40B, two carriages 38 each having a scorer 40A, or other combinations of a plurality of carriages 38, each having a scorer 40A or blade 40B. As another example, cooperating male and female elements, such as the pivot 32 and pivot receiving area (not shown), the rib 24 and rib-receiving recess 30, or the carriage guiding portion 28 and the rail-receiving portion 29, can be reversed from the male and female elements shown.

In another embodiment, the trimmer may have a second rail assembly that is pivotally connected to the base and a second channel. The second rail assembly may have measuring indicia and may be transparent to allow measuring and a view of the material to be cut. The second rail assembly may be positioned opposite of the first rail assembly. In yet another embodiment, the second rail assembly may have at least one carriage mounted to the rail assembly. The at least one carriage of the second rail assembly may have a protrusion that functions as a blade, a scorer, a paper curler, or any other desirable function.

In another embodiment, the base is wider than that depicted in FIG.1 to provide for additional working surface. In another embodiment, the working surface has a greater surface area to accommodate a second rail assembly.

In another embodiment, the trimmer may have a second swing out arm to extend the working surface of the base. The second swing out arm may be located opposite of the first swing out arm. The second swing out arm may have a first end pivotally connected to the base and a second end, which may swing freely towards or away from the base. The second swing out arm has an arm working surface that is flush with and substantially coplanar with the working surface of the base.

In yet another embodiment, the position of the rail assembly 26 and the swing out arm 50 as depicted in FIG.1 may be switched. In this embodiment, the rail assembly is in the former position of the swing out arm and the swing out arm is in the former position of the rail assembly.

In general, while the present invention has been shown and described in terms of a preferred embodiment, it is recognized that equivalents, alternatives, and modifications aside form those expressly stated are possible and within the scope of the invention.

We claim:

1. A trimmer, comprising:
a base, having a working surface and a channel, wherein the working surface has a first length;
a rail assembly substantially parallel to and adjacent to the channel, having a cutting portion and at least one storage portion, wherein the rail assembly is pivotally connected to the base, the cutting portion has a second length approximately equal to the first length, and the portions are contiguous with the cutting portion;
at least one carriage slidably connected to the rail assembly, wherein the at least one carriage has a protrusion positioned to be received within the channel; and
a swing-out arm pivotally connected to the base.

2. The trimmer of claim 1, wherein the at least one carriage is removably connected to the rail assembly.

3. The trimmer of claim 1, wherein the protrusion is a blade.

4. The trimmer of claim 3, wherein the blade has a coating.

5. The trimmer of claim 4, wherein the coating is a combination of titanium nitride and chromium nitride.

6. The trimmer of claim 1, wherein the protrusion is a scorer.

7. The trimmer of claim 6, wherein the scorer has a coating.

8. The trimmer of claim 7, wherein the coating is a combination of titanium nitride and chromium nitride.

9. The trimmer of claim 1, wherein the at least one carriage comprises a plurality of carriages, each of said carriages having a protrusion selected from the group consisting of a blade and a scorer.

10. The trimmer of claim 1, wherein the at least one carriage comprises a first carriage and a second carriage, wherein the protrusion of the first carriage is a blade and the protrusion of the second carriage is a scorer, and the blade and the scorer have a coating comprised of a combination of titanium nitride and chromium nitride.

11. The trimmer of claim 1, wherein the base has at least one rib and the rail has at least one corresponding rib-receiving recess for securing the position of the rail against the base.

12. The trimmer of claim 1, wherein the rail has at least one rib and the base has at least one corresponding rib-receiving recess for securing the position of the rail against the base.

13. The trimmer of claim 1, wherein the at least one carriage has an arcuate surface adjacent to the protrusion.

14. The trimmer of claim 9, wherein the at least one carriage each has an indicator representing the position of the protrusion.

15. The trimmer of claim 14, wherein the indicator represents the function of the protrusion.

16. The trimmer of claim 1, further comprising a swing-out arm pivotally connected to the base and having an arm working surface.

17. The trimmer of claim 16, wherein the working surface of the base and the arm working surface have measuring indicia.

18. The trimmer of claim 16, wherein the swing-out arm has a foot, the base has a foot-receiving recess, and the foot removably snap-fits into the foot-receiving recess.

19. The trimmer of claim 18, wherein the foot is of a height sufficient to ensure that the arm working surface remains substantially flush and coplanar with the working surface of the base.

20. The trimmer of claim 1, wherein the rail is substantially transparent and has measuring indicia.

21. The trimmer of claim 1, wherein the working surface of the arm is coplanar with the working surface of the base.

22. A trimmer, comprising:
a base having a working surface and a channel;
a rail pivotally connected to the base, wherein the rail is parallel to the channel and the rail has a central cutting region and two distal storage regions;
a first carriage slidably mounted to the rail, wherein the first carriage has a blade positioned for being received within the channel;
a second carriage slidably mounted to the rail, wherein the second carriage has a scorer positioned for being received within the channel;
wherein the first carriage may be positioned in a storage region while the second carriage may be slid along the entire length of the cutting region;
wherein the second carriage may be positioned in a storage region while the first carriage is slid along the entire length of the cutting region; and
a swing-out arm pivotally connected to the base, wherein the arm is coplanar with the working surface of the base

23. A trimmer comprising:
a base;
a rail pivotally connected to the base; and
two carriages slidably attached to the rail.

24. A trimmer comprising:
a base;
a rail pivotally connected to the base; and
a swing-out arm pivotally connected to the base and having an arm working surface.

25. The trimmer of claim 24, wherein the working surface of the arm is coplanar with the working surface of the base.

26. The trimmer of claim 24, wherein the swing-out arm has a foot, the base has a foot-receiving recess, and the foot removably snap-fits into the foot-receiving recess.

27. The trimmer of claim 24, wherein the swing-out arm has a working surface with measuring indicia.
